(19) United States
(12) Patent Application Publication
(10) Pub. No.: US 2025/0258683 A1
(43) Pub. Date: Aug. 14, 2025

(54) FINITE STATE MACHINES WITH MULTI-STATE RECONCILIATION IN DISTRIBUTED COMPUTING INFRASTRUCTURES

(71) Applicant: NVIDIA Corporation, Santa Clara, CA (US)

(72) Inventor: Kishore KARTHIKEYAN, Fremont, CA (US)

(73) Assignee: NVIDIA Corporation, Santa Clara, CA (US)

(21) Appl. No.: 18/441,841

(22) Filed: Feb. 14, 2024

(51) Int. Cl. G06F 9/448

(52) U.S. Cl. CPC G06F 9/4498

(57) ABSTRACT

The technical solutions disclosed are directed to a multi-state reconciliation finite state automata operator framework. The system and methods can identify one or more states between an initial state and a final state of an application executed by a service and one or more parameters corresponding to timing of implementation of the one or more states. The systems and method can provide a model configured to manage progress corresponding to the one or more states of the application to determine, using a first matrix, a current state of the one or more states of the application and determine, using a second matrix, a parameter of the one or more parameters corresponding to a timing of implementation of the current state. The systems and method can provide to the service an indication of the progress of the application.

### BACKGROUND

When using cloud systems to implement different processes, Finite State Automata (FSA)—also known as finite state machines—can be used to model such processes. Implementing multi-state FSA models in a cloud computing environment can be challenging due to an absence of a comprehensive framework for deploying FSA as multi-state cloud-native models within cloud orchestration tools. Present solutions are limited in that their FSA implementations fail to effectively handle intricate state transitions and provide sufficient granularity in the state of the processes executed. This can make it challenging to provide reliable, cloud-based, level-triggered structures to accommodate effective monitoring of numerous states and granular transitions for a variety of cloud-based applications.

### SUMMARY

Embodiments of the present disclosure relate to frameworks for multi-state reconciliation in finite state automata models deployed in distributed computing environments, such as datacenters, cloud computing systems, or other hyperconverged computing infrastructures. Systems and methods are disclosed that facilitate a cloud-native framework that efficiently manages multi-state FSA models for a variety of applications, utilizing matrices tracking state transition and state delays to guide state changes and timing.

In contrast to conventional systems, such as those described above, the technical solutions provided herein facilitate a cloud-native framework for managing multi-state FSA models to track the state and transitions of the processes executed for a variety of applications at a highly granular level. The present technical solutions facilitate a framework that guides dynamic state changes and controls transition timing, which allows for versatile and level-triggered handling of multi-state FSA models in cloud-native environments. The present technical solutions simplify deployment, automation, and state management of the executed processes by providing hooks for application-specific states and timing requirements. The technical solutions can allow users to provide FSA topology and matrices for state data and delay data. The FSA topology and matrices can be provided together with a framework of a cloud-native environment (e.g., Kubernetes) to process state logic, implementation, error handling, and reconciliation, following the FSA progress through defined states.

### BRIEF DESCRIPTION OF THE DRAWINGS

The present systems and methods for multi-state reconciliation finite state automata operator framework are described in detail below with reference to the attached drawing figures, wherein:

FIG. 1 is a block diagram of an example system for a multi-state reconciliation finite state automata operator framework suitable for use in implementing some embodiments of the present disclosure;

FIG. 2 is a block diagram of an example computing device suitable for use in implementing some embodiments of the present disclosure;

FIG. 3 is a block diagram of an example data center suitable for use in implementing some embodiments of the present disclosure; and

FIG. 4 is a flow diagram of an example method of a multi-state reconciliation finite state automata operator framework suitable for use in implementing some embodiments of the present disclosure.

### DETAILED DESCRIPTION

Systems and methods are disclosed related to multi-state reconciliation in finite state automata models deployed in distributed computing environments.

The present technical solutions provide a cloud-native framework for managing multi-state Finite State Automata (FSA) for a variety of different applications operating across various states. The framework can use a State Transition Matrix to guide dynamic state changes and a State Delay Matrix to control transition timing between state changes, providing a versatile, level-triggered infrastructure for multi-state FSA models in cloud-native environments.

Presently, implementing cloud-based multi-state FSA models is challenging due to a lack of a comprehensive frameworks capable of deploying FSA as multi-state cloud-native models within the context of modern cloud orchestration, such as Kubernetes. Despite cloud orchestration tools (such as Kubernetes) being widely available, their lack of a dedicated cloud-native infrastructure to effectively handle intricate state transitions, probabilistic state models, and seamless integration with existing cloud-native automation tools make it difficult to implement applications based on Deterministic FSA (DFA) or Non-deterministic FSA (NDFA). Further, it is challenging to provide a robust, level-triggered structure that can accommodate many (e.g., more than two, such as the current and the next) states and transitions for various (e.g., cloud-based) applications, while also allowing for efficient operation and automation via bespoke resources.

The present technical solutions can overcome these challenges by providing a multi-state, level-triggered structure that simplifies deployment, automation, and state management. The present technical solutions can further provide hooked handlers for implementing application-specific states and timing requirements. To deploy the present technical solutions with an application, for example, a topology of the FSA, a State Transition Matrix, a State Delay Matrix, and in the event of a NDFA a Probabilistic Transition Matrix are provided. The State Transition Matrix enables managing and navigating the multi-level FSA's topology. The State Delay Matrix enables managing temporal dynamics and transition time limitations. In the case of a NDFA a Probabilistic Transition Matrix manages probabilities that particular state outcomes will take place, given the current state of the process.

With these inputs, the logic for handling each state, the actual implementation of state transition, error handling and reconciling can be executed by the framework. The framework performs a reconciling function (i.e., operates as a controller) to persistently reconcile the states in accordance with the data in the matrices to ensure that the FSA progresses through the states defined by the topology and the state transition logic. A State Transition manager handles the FSM topology and change states using the State Transition Matrix. A Transition Delay Manager handles timing for transition from one state to another state according to the State Delay Matrix, which provides time parameters for each state and transitions. A Plugin Manager provides application handlers to assist with movement across the states and transitions. An Adaptive State Manager notifies the application on time constraints and parameters for state changes. A Reconciling Controller provides a control loop that continually reconciles the present and desired states.

The present technical solutions can provide a versatile Cloud-Native FSA Framework deployable in endpoint clusters (e.g., Kubernetes), that simplifies the design and management of FSA models by offering a multi-state reconciliation operator framework automating state transition logic, empowering designers to focus solely on the business logic of each state, while also aiding developers, administrators, and testers by facilitating FSA implementation, automation, and testing through native system (e.g., Kubernetes) objects.

The systems and methods of the technical solutions described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, application process or state modeling, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, modeling systems for application process modeling or control, systems for performing collaborative content creation for 3D assets, systems implemented at least partially using cloud computing resources, and/or other types of systems.

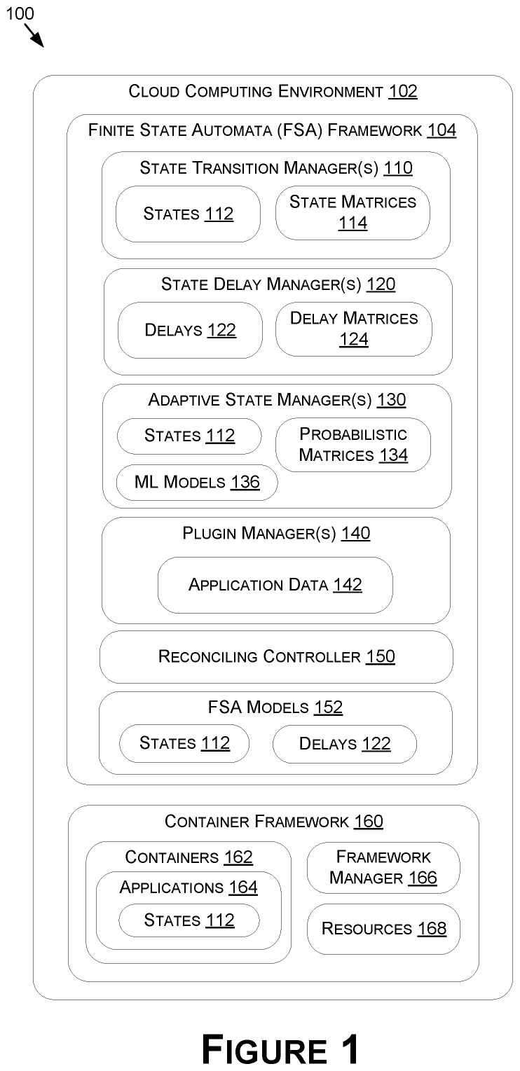

With reference to FIG. 1, an example system 100 of a multi-state reconciliation finite state automata operator framework is illustrated. System 100 can include cloud computing environment 102 including, executing or providing one or more Finite State Automata (FSA) frameworks 104 and container frameworks 160. Each FSA framework 104 can include one or more state transition managers 110, state delay managers 120, adaptive state managers 130, plugin managers 140, reconciling controllers 150 and FSA models 152. Each state transition manager 110 can include, execute, provide, detect, monitor or process one or more states 112 and state matrices 114. Each delay manager 120 can include, execute, provide, detect, monitor or process one or more delays 122 and delay matrices 124. Each adaptive state manager 130 can include, execute, provide, detect, monitor or process one or more states 112, probabilistic matrices 134 and machine learning (ML) models 136. Each plugin manager 140 can include, execute, provide, detect, monitor or process one or more application data 142. Each FSA model 152 can include states 112 and delays 122 for a particular containerized executed application 164. Each container framework 160 can include one or more containers 162 including, enclosing, executing or providing one or more applications 164 that can be at any one or more states 112 of operation. Container framework 160 can include one or more framework managers 166 and resources 168 supporting the operation of applications 164 at containers 162.

Cloud computing environment 102 can include any combination of hardware and software for delivering computing services (e.g., executing applications) for access or use by client device(s) over a network. Client computing environment 102 can include any number of interconnected computing devices (e.g., servers) and storage systems that can operate collectively to deliver computing services, such as to provide containerized applications 162 via a network (e.g., internet, wide area network, cellular network, local area network or any communication network). Cloud computing environment 102 can include, for example, data centers housing the physical infrastructure, such as servers for hosting applications 164 and data (e.g., data provided by applications 164). Cloud computing environment 102 can include storage devices for data retention as well as networking equipment for data communication or transmission.

Cloud computing environment 102 can include cloud services that can allocate and manage virtualized resources 168, scaling such resources for containers 162 and their applications 164 dynamically based on varying resource demands of the applications 164 or their containers 162. Users can use their own computing devices (e.g., computers or smartphones) to access the services provided by the cloud computing environment 102 remotely through web interfaces or applications, eliminating the requirement for local installations. Cloud computing environment 102 can include and/or operate FSA framework 104 that can facilitate identifying, monitoring and controlling states 112 and delays 122 of the applications 164 during their executions on or within the container framework 160.

Although example system 100 illustrates the cloud computing environment 102 as the environment in which the FSA framework 104 and container framework 160 are implemented, it is understood that other example computing environments can be used instead, such as individual servers, virtual machines, personal computers, or any other computing devices capable of processing the features of the present technical solutions and making the applications and their data accessible to clients or users via a network (e.g., the Internet).

Container framework 160 can include any combination of hardware and software that manages and orchestrates deployment, scaling, and operation of containers 162 and their executed applications 164. Container framework 160 can include a system for automating deployment, scaling and management of containerized applications 164. Container framework 160 can include different functions, features or components that can coordinate or collaborate to oversee, manage or control execution of containerized applications 164. Container framework 160 can include functionality to operate a controller pattern, using a control loop to provide a desired state 112 of an executing application 164. For example, applications 164 can be packaged, executed or operated within containers 162 that can include or encapsulate all of the dependencies, resources or data for execution of the applications 164 and which can run consistently across different environments. Container framework 160 can manage the lifecycle of the executed applications 164, monitoring for failures, errors, delays or any execution issues and automatically adjusting, replacing or scaling containers 162, as needed. Container framework 160 can facilitate load balancing, data storage, and networking, enabling applications to communicate and access resources of the cloud computing environment 102. Users can interact with container framework 160 via interfaces which can include, for example command-line interface or graphical dashboards. The interfaces can define the application's structure and behavior.

Container 162 can include any combination of hardware and software for generating, providing or facilitating a self-contained and isolated environment that encapsulates an application 164 to be executed along with any resources or dependencies, such as libraries and configurations. Container 162 can provide the functionalities to package and run applications 164, to allow the applications 164 to operate or execute reliably across different computing environments (e.g., varying operating systems, types of machines or any underlying structure). Container 162 can share the host operating system's kernel and maintain its own isolated file systems and runtime environments, enabling applications 164 executed therein to run in isolation without interfering with other applications 164 or processes that may be executed on the same cloud computing environment 102.

Applications 164 can include any functions or software programs that can be executed on a cloud computing environment 102, including any programs, functions or software operating in a container 162. Applications 164 can include, for example, a web server for providing solutions for websites, a service or a microservice for another application or a platform, an e-commerce platform for providing online shopping, a database, a machine learning framework for training or providing ML models, a software development tool, a content delivery network or its features, a web-based service, such as a website or any other application or a feature. As applications 164 can be executed within a container 162, the container 162 can bundle or encapsulate the application's code, runtime dependencies, system libraries, and configuration settings into a single, portable package, allowing the application to run consistently and predictably regardless of any variations in the underlying computing environments. Accordingly, container framework 160 and its containers 162 can be provided on development laptops, online servers or cloud computing environments 102.

States 112 can include any distinct operational condition or a phase that an application can experience or assume during its lifecycle. States 112 can be defined, described or indicated based on the specific behavior and requirements of the application 162 at a particular moment. For example, states 112 can include an initialization state 112 (e.g., init state), in which the application 162 can set up its environment and resources for anticipated (e.g., future) execution. States 112 can include a registered state 112, which can correspond to the state in which the application 164 has completed its registration (e.g., application is documented, recognized or recorded as operational or active). States 112 can include a provisioned state 112, in which the application 164 has been allocated, configured and made ready for use or execution. States 112 can include an execution or a running state 112 (e.g., in-use state), in which the application 164 can perform its execution or tasks (e.g., operation of the application code providing the services or output for which the application 164 is designed). States 112 can include a waiting or pausing state 112, which can correspond to a time period during which the application 164 is idle or awaiting a particular input or a particular event to occur to continue operation. States 112 can include a stage or level of execution, pertaining to a stage or level of the operation that the application 164 is performing. States 112 can include a decommissioned state 112, such as a state when the application 164 has been taken out of service and is no longer operational. States 112 can include an update state, during which the application 164 can undergo changes or updates. States 112 can include a completion or termination state 112, which can indicate the end of the application's execution. States 112 can include intermediate states or custom-defined states tailored to unique functionalities and logic of an application 164.

Framework manager 166 can include any combination of hardware and software for controlling managing or overseeing implementation of the containerized environment, provisioning of resources 168 and operation of applications 164 within containers 162. Framework manager 166 can include functionality for allocation of resources 168 including processing and storage resources, allocating CPU or memory, or providing any hardware or software functionality for facilitating operation of the containers 162 and applications 164. Framework manager 166 can control and implement deployment and scaling of applications 164, manage networking configurations, and manage, monitor and handle lifecycle events of the containers 162, such as scaling up or down based on demand. Framework manager 166 can facilitate error handling and fault tolerance, ensuring that applications continue running reliably, including interacting, using and coordinating FSA framework 104 and any of its features or functions.

Resources 168 can include any computing elements, data or features for operation of the containers 162 and/or applications 164. Resources 168 can include, for example, central processing unit (CPU) provisioning, such as allocation of a certain number of cycles for operation, amount of processing power available for executing tasks within a container 162, amount or locations of memory (RAM) to be provided for storing data and program instructions during runtime, amount or locations of storage in hard drives to be used for data storage, allocation of network bandwidth and connectivity functionalities to facilitate external communication, graphics processing unit (GPU) resources for specialized tasks or accelerations, or any other hardware or software infrastructure features.

Finite state automata (FSA) framework 104 can include any combination of hardware and software for providing, executing or managing FSA models 152 within a computing environment, such as a cloud computing environment 102, a server, a computing device, a virtual machine or any other environment. FSA framework 104 can include a structured environment for providing or managing multi-state FSA models 152 within cloud-native environments. FSA framework 104 can utilize state matrices 114 to determine and monitor transitions of states 112 of the applications 164 executed in containers 162, as well as guide dynamic changes of such states 112. FSA framework 104 can utilize delay matrices 124 to determine and monitor, as well as control, timing of the transitions between different states 112 as provided, monitored or determined by an FSA model 152 for any particular application 164.

FSA framework 104 can generate, execute and provide output from Finite State Automata (FSA) models 152. FSA models 152 can include any model to represent and manage the updating or dynamic states 112 and transitions of the containerized applications 164. FSA models 152 can include indications of states 112 and delays 122. FSA models 152 can include, for example, any deterministic (e.g., a 100% certainty of the determined state of the application 164) or non-deterministic (e.g., a less than 100 certainty of the determined state actually occurring) model. For instance, FSA models 152 can define a state 112 as a deterministic state (e.g., probability 100% of the application being in the particular state 112). For example, FSA model 152 can define one or more states 112 as non-deterministic states 112, such that there is a 30% chance that the application 164 is in a first state 112 (e.g., initialization state), 50% chance that it is in a second state 112 (e.g., registered state) and 20% chance that it is in a third state 112 (e.g., provisioned state).

FSA model 152s can determine and indicate deterministic and non-deterministic states 112 and delays 122. For instance, FSA model 152 can determine and indicate that an application 164 exists in an initializing state 112, a running state 112, or an error state 112, and can indicate if the state 112 is deterministic (e.g., 100% probability for the indicated state) or non-deterministic (e.g., probability for indicated state is less than 100%). For instance, FSA model 152 can determine and indicate that a time of the occurrence of the transition or the delay or a time duration until transitions between the states 112. Such transitions can be deterministic or non-deterministic.

FSA models 152 can determine and indicate delays 122 between states 112 (e.g., time until the next state transition is completed). FSA model 152 can determine or indicate deterministic time-based delays 122 or probabilistic delays 122, which can represent the deterministic or non-deterministic duration of time an application spends in each state 122 before transitioning to another. For example, in a probabilistic FSA model 152, an application may have a higher probability (e.g., 90%) of transitioning from an initializing state 112 to a running state 112 after a shorter delay, while transitioning to an error state 112 might have a lower probability (e.g., 10%).

FSA framework 104 can provide or facilitate a level-triggered infrastructure for FSA models 152. FSA framework 104 can include the functionality for monitoring, tracking and managing transition and timing of the states 112 of the containerized applications 164 for a variety of different states 112 that are between the initiation state 112 and the complete state 112, such as for example, a registered state 112, a provisioned state 112, an available state 112, an in-use state 112, an executing state 112, a pausing state 112, an error state 112, a decommissioned state 112, a deleted state 112 or any other state in which the application 164 may be, at a given moment.

FSA framework 104 can provide deployment, automation, and management of FSA models 152 by allowing users to define a topology of the FSA model 152 and relevant matrices 114, 124, along with custom logic for handling each state 112. FSA framework 104 can operate as a controller, allowing for the FSA to progress through defined states 112, effectively handling state transitions, temporal dynamics, and error reconciliation.

State transitions manager 110 can include any combination of hardware and software that determines, monitors or manages processes involving one or more states 112 for an FSA model 152. State transitions manager 110 can handle the topology of the FSM model and the changes of states based on a state matrix 114, using data provided by the application 164. State transition manager 110 can include an input interface to the FSM framework 104 for an FSM model 152. State matrix 114 can provide a custom object or feature that can include fields for application 164 to input or enter values corresponding to the topology of the FSM model 152 for that application 164. Topology data can include, for example, events or actions that trigger or correspond to transitions between state, data on when a particular event can occur in a particular state 112 and what needs to occur before a next state 112 is reached. The topology can be closed looped, so as to allow for the application or container to return back to an operational state in the event implementation stalls.

State transitions manager 110 can oversee the transition of a system or application from one state 112 to another based on predefined rules and conditions. State transitions manager 110 can use a state matrix 114 and its values or indicators to follow or monitor the sequence and conditions for state changes. State transitions manager 110 can follows the specified state transitions, updating its current state to match or indicate the current state or a desired state and handle any desired actions or operations during the process.

State matrices 114 can include any structured data representation (e.g., data structure, table or a matrix) used for state-based processes, such as those monitored by an FSA model 152. State matrix 114 can include designated fields for entry of values indicating, defining or managing the transitions between different states 112 in a process. Typically depicted as a table or matrix, state matrix 114 can indicate states 112 of an application 164, along with the permissible transitions between those states. Each entry in the state matrix 114 can indicate a transition from one state 112 to another and may include additional information, such as transition indications or conditions, probabilities, or timing constraints.

State delay manager 120 can include any combination of hardware and software for monitoring and controlling the timing and delays associated with transitions between different states within a process of an application 164. State delay manager 120 can operate in a user configured automated mode in which a user can provide a state matrix 114 indicating the time to be spent (e.g., delay 122) on each state 112, allowing the state delay manager 120 to ensure that the state transitions are implemented in accordance with the parameters in the delay matrix 124. Delay matrix 122 can include parameters corresponding to the time the application 164 is to take at each state as well as the transition time between the states. For example, if an application 164 includes three states, state matrix 122 can indicate that the first state should have a duration of 20 seconds, a second state should have a duration of 60 seconds and a third state should have a duration of 120 seconds. Similarly, state matrix 122 can indicate transition times between each of the states and follow the delay matrix 122 to ensure timely execution of the application 164. State delay manager 120 can include a manual transition mode of operation in state machine can be handled manually allowing the user to provide oversight and trigger changes, allowing movement to the next state 112.

Delays 122 can include any values or parameters indicative of a period of time between the initiation of a particular action or event and its actual occurrence. For instance, delay 122 can be caused by factors such as network latency, processing time, buffering, or congestion and can be measured or controlled to allow for predictable operations in applications 164. Delay 122 can correspond to a time duration for which an application 164 will be in a particular state 122. Delay 122 can correspond to a time duration of transition between one state and the next state. Delay 122 can correspond to a time duration from a beginning of one state 112 until a beginning of another (e.g., next) state 122. Delay 122 can correspond to a time duration from a beginning of execution of an application 164 until its end, for any one state, any plurality of states, or all states (e.g., start to finish).

Delay matrices 124 can include any structured data representation used for FSA models and indicative of delays 122 for any one or more applications 164. Delay matrix 124 can include a data structure, a table or a matrix which can be used to indicate, store, access, monitor or manage the timing and delays associated with state 112 transitions within a process. Each entry in the delay matrix 124 can corresponds to a specific event, process, part of a process or transition between processes or states and can define the time parameters or delays (e.g., time durations) that should be applied during that event, process, part of process or transition.

Adaptive state manager 120 can include any combination of hardware and software for making non-deterministic (e.g., probabilistic) state determinations, such as when state 112 transitions, the number of required trials to move between states 112, or related delays 122 associated with state changes remain uncertain. Adaptive state manger 120 can include or utilize machine learning to model state transitions dynamically, learning about state 112 transitions and delays 122 and implementing such probabilistic determinations to estimate the states 112, the delays 122 along with their respective probabilities.

Adaptive state manager 120 can be deployed in a test network with training data to gain insights into the FSM and state transitions, and subsequently, it can be deployed in a production environment for a particular one or more applications 164. Adaptive state manager can utilize Bayesian learning, allowing it to adapt and fine-tune its understanding of the FSM (e.g., fine tuning the FSM model 152 determinations) based on changes in state objects within the production environment, supporting progressive learning with each state object modification.

Probabilistic matrices 134 can include any structured data representations (e.g., data structures, matrices or tables) that include indications and/or likelihoods or probabilities of various events, outcomes, or transitions for a particular application 164. Probabilistic matrices 134 can include probabilities for any non-deterministic states in a non-deterministic state matrix 114 or delay matrix 124 (e.g., matrix including parameters for states 112 and/or delays 122 along with probabilities for such states 112 or delays 122). For example, probabilistic matrix 134 can include a tabular format, in which each entry corresponds to the probability of a specific state 112, specific state transition or specific delay 122 with respect to the transition or state 112, along with probabilities (e.g., greater than 0% and less than 100%, or greater than 0 and less than 1), thereby indicating probability for the given state 112 or delay 122 (e.g., time period or delay range until state transition) to occur.

Machine learning (ML) models 136 can include any machine learning or artificial intelligence models for modeling and determining states 112, delays 122, state transitions along with any probabilities for the particular determination. ML models 136 can include the functionality to dynamically learn about state delays 122 and states 122 (e.g., state transitions). ML models 136 can use machine learning algorithms to analyze historical data (e.g., on various states, state delays for a variety of applications) and generate predictive models that capture the patterns and dynamics of state transitions and associated delays within the system. For example, a ML model 136 can analyze the historical behavior of an application 164 and learn expected timing and sequencing of state transitions, and adaptively adjust its predictions based on evolving conditions (e.g., states 112, delays 122).

Plugin manager 140 can include any combination of hardware and software for integrating application state logic libraries provided by applications 164. For example, in a situation in which states 112, such as “Init,” “InProgress,” and “Ready” are used for an application 164, the application 164 can furnish instructions or scripts, such as hooked state handlers (e.g., HandleInit( ), HandleInProgress( ), and HandleReady( )), each one of which can be responsible for execution when in its designated respective state. These instructions or handlers can include information, commands and data for signaling between states, receiving state-related notifications, and managing state transitions. Plugin manager 140 can then collaborate with the state transition manager 110 to facilitate the state transitions within the system.

Application data 142 can include any information about the application 164 that can be used by the FSA framework 104 and/or FSA model 152. For instance, application data 142 can include data or input parameters for the state matrices 114 and delay matrices 124 which can be received by the state transition manager 110. Application data 142 can include designations or indications of particular states 112 for a particular application 164, as well as any scripts or hooked state handlers for execution during any particular state (e.g., state handlers). Application data 142 can include logic governing the behavior of application 164 behavior in various states, specifying the number and types of states it can assume, hooks enabling communication across states, mechanisms for notifying external entities of state changes, and rules governing state transitions.

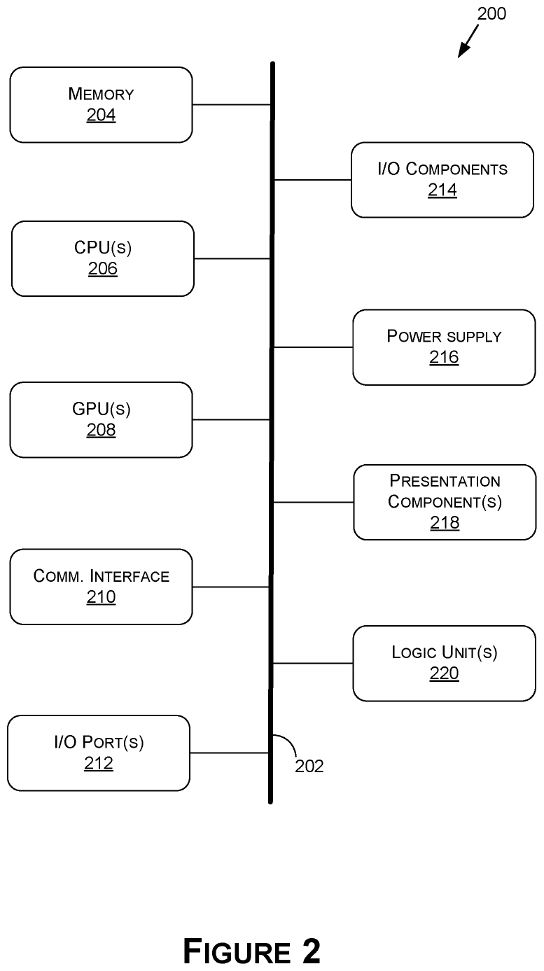

FIG. 2 is a block diagram of an example computing device(s) 200 suitable for use in implementing at least some embodiments of the present disclosure. For example, computing device 200 can include the underlying hardware framework for implementing system 100 from FIG. 1. Computing device 200 may include an interconnect system 202 that directly or indirectly couples the following devices: memory 204, one or more central processing units (CPUs) 206, one or more graphics processing units (GPUs) 208, a communication interface 210, input/output (I/O) ports 212, input/output components 214, a power supply 216, one or more presentation components 218 (e.g., display(s)), and one or more logic units 220. In at least one embodiment, the computing device(s) 200 may comprise one or more virtual machines (VMs) or features of a cloud computing system or environment and/or any of the components thereof may comprise virtual components (e.g., virtual hardware components). For non-limiting examples, one or more of the GPUs 208 may comprise one or more vGPUs, one or more of the CPUs 206 may comprise one or more vCPUs, and/or one or more of the logic units 220 may comprise one or more virtual logic units. As such, a computing device(s) 200 may include discrete components (e.g., a full GPU dedicated to the computing device 200), virtual components (e.g., a portion of a GPU dedicated to the computing device 200), or a combination thereof.

Although the various blocks of FIG. 2 are shown as connected via the interconnect system 202 with lines, this is not intended to be limiting and is for clarity only. For example, in some embodiments, a presentation component 218, such as a display device, may be considered an I/O component 214 (e.g., if the display is a touch screen). As another example, the CPUs 206 and/or GPUs 208 may include memory (e.g., the memory 204 may be representative of a storage device in addition to the memory of the GPUs 208, the CPUs 206, and/or other components). In other words, the computing device of FIG. 2 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” “cloud computing environment” and/or other device or system types, as all are contemplated within the scope of the computing device of FIG. 2.

The interconnect system 202 may represent one or more links or busses, such as an address bus, a data bus, a control bus, or a combination thereof. The interconnect system 202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 206 may be directly connected to the memory 204. Further, the CPU 206 may be directly connected to the GPU 208. Where there is direct, or point-to-point connection between components, the interconnect system 202 may include a PCIe link to carry out the connection. In these examples, a PCI bus need not be included in the computing device 200.

The memory 204 may include any of a variety of computer-readable media. The computer-readable media may be any available media that may be accessed by the computing device 200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 206 may be configured to execute at least some of the computer-readable instructions to control one or more components of the computing device 200 to perform one or more of the methods and/or processes described herein. The CPU(s) 206 may each include one or more cores (e.g., one, two, four, eight, twenty-eight, seventy-two, etc.) that are capable of handling a multitude of software threads simultaneously. The CPU(s) 206 may include any type of processor and may include different types of processors depending on the type of computing device 200 implemented (e.g., processors with fewer cores for mobile devices and processors with more cores for servers). For example, depending on the type of computing device 200, the processor may be an Advanced RISC Machines (ARM) processor implemented using Reduced Instruction Set Computing (RISC) or an x86 processor implemented using Complex Instruction Set Computing (CISC). The computing device 200 may include one or more CPUs 206 in addition to one or more microprocessors or supplementary co-processors, such as math co-processors.

In addition to or alternatively from the CPU(s) 206, the GPU(s) 208 may be configured to execute at least some of the computer-readable instructions to control one or more components of the computing device 200 to perform one or more of the methods and/or processes described herein. One or more of the GPU(s) 208 may be an integrated GPU (e.g., with one or more of the CPU(s) 206 and/or one or more of the GPU(s) 208 may be a discrete GPU. In embodiments, one or more of the GPU(s) 208 may be a coprocessor of one or more of the CPU(s) 206. The GPU(s) 208 may be used by the computing device 200 to render graphics (e.g., 3D graphics) or perform general purpose computations. For example, the GPU(s) 208 may be used for General-Purpose computing on GPUs (GPGPU). The GPU(s) 208 may include hundreds or thousands of cores that are capable of handling hundreds or thousands of software threads simultaneously. The GPU(s) 208 may generate pixel data for output images in response to rendering commands (e.g., rendering commands from the CPU(s) 206 received via a host interface). The GPU(s) 208 may include graphics memory, such as display memory, for storing pixel data or any other suitable data, such as GPGPU data. The display memory may be included as part of the memory 204. The GPU(s) 208 may include two or more GPUs operating in parallel (e.g., via a link). The link may directly connect the GPUs (e.g., using NVLINK) or may connect the GPUs through a switch (e.g., using NVSwitch). When combined together, each GPU 208 may generate pixel data or GPGPU data for different portions of an output or for different outputs (e.g., a first GPU for a first image and a second GPU for a second image). Each GPU may include its own memory or may share memory with other GPUs.

In addition to or alternatively from the CPU(s) 206 and/or the GPU(s) 208, the logic unit(s) 220 may be configured to execute at least some of the computer-readable instructions to control one or more components of the computing device 200 to perform one or more of the methods and/or processes described herein. In embodiments, the CPU(s) 206, the GPU(s) 208, and/or the logic unit(s) 220 may discretely or jointly perform any combination of the methods, processes and/or portions thereof. One or more of the logic units 220 may be part of and/or integrated in one or more of the CPU(s) 206 and/or the GPU(s) 208 and/or one or more of the logic units 220 may be discrete components or otherwise external to the CPU(s) 206 and/or the GPU(s) 208. In embodiments, one or more of the logic units 220 may be a coprocessor of one or more of the CPU(s) 206 and/or one or more of the GPU(s) 208.

Examples of the logic unit(s) 220 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 210 may include one or more receivers, transmitters, and/or transceivers that enable the computing device 200 to communicate with other computing devices via an electronic communication network, included wired and/or wireless communications. The communication interface 210 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 220 and/or communication interface 210 may include one or more data processing units (DPUs) to transmit data received over a network and/or through interconnect system 202 directly to (e.g., a memory of) one or more GPU(s) 208.

The I/O ports 212 may enable the computing device 200 to be logically coupled to other devices including the I/O components 214, the presentation component(s) 218, and/or other components, some of which may be built in to (e.g., integrated in) the computing device 200. Illustrative I/O components 214 include a microphone, mouse, keyboard, joystick, game pad, game controller, satellite dish, scanner, printer, wireless device, etc. The I/O components 214 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 200. The computing device 200 may be include depth cameras, such as stereoscopic camera systems, infrared camera systems, RGB camera systems, touchscreen technology, and combinations of these, for gesture detection and recognition. Additionally, the computing device 200 may include accelerometers or gyroscopes (e.g., as part of an inertia measurement unit (IMU)) that enable detection of motion. In some examples, the output of the accelerometers or gyroscopes may be used by the computing device 200 to render immersive augmented reality or virtual reality.

The power supply 216 may include a hard-wired power supply, a battery power supply, or a combination thereof. The power supply 216 may provide power to the computing device 200 to enable the components of the computing device 200 to operate.

The presentation component(s) 218 may include a display (e.g., a monitor, a touch screen, a television screen, a heads-up-display (HUD), other display types, or a combination thereof), speakers, and/or other presentation components. The presentation component(s) 218 may receive data from other components (e.g., the GPU(s) 208, the CPU(s) 206, DPUs, etc.), and output the data (e.g., as an image, video, sound, etc.).

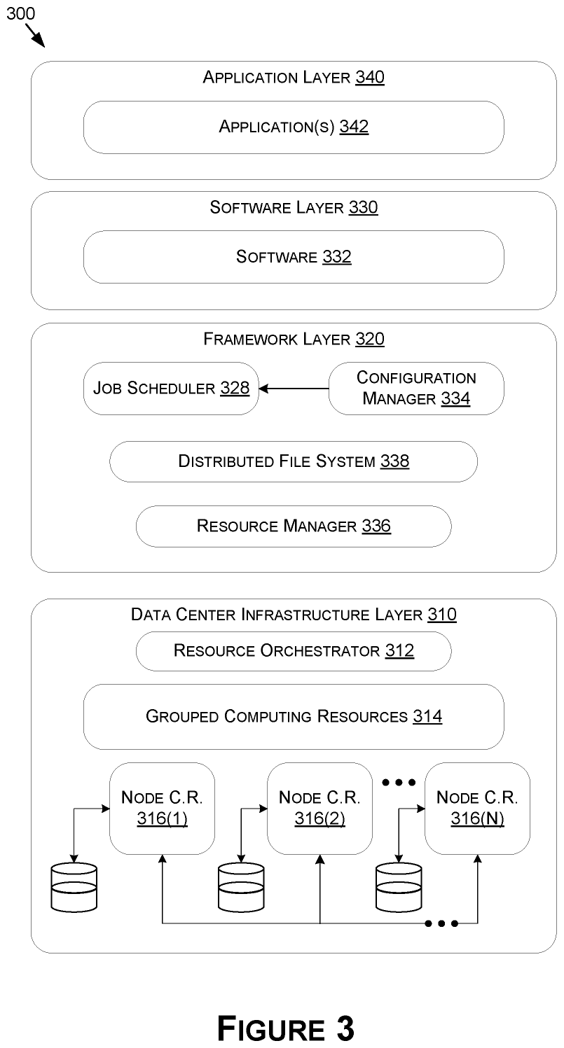

FIG. 3 illustrates an example data center 300 that may be used in at least one embodiments of the present disclosure, such as for example cloud computing environment 102 of system 100. The data center 300 may include a data center infrastructure layer 310, a framework layer 320, a software layer 330, and/or an application layer 340. Data center 300 can facilitate implementation of, or can include, be integrated with, or be combined with, at least a part a cloud computing environment 102 in system 100, such as a container framework 160 or an FSA framework 104, and vice versa.

As shown in FIG. 3, the data center infrastructure layer 310 may include a resource orchestrator 312, grouped computing resources 314, and node computing resources (“node C.R.s”) 316(1)-316(N), where “N” represents any whole, positive integer. As data center infrastructure layer 310 can be included within, or comprise at least a portion of, a cloud computing environment 102, grouped computing resources 314 and node computing resources 316 can include, for example, resources 168, and vice versa. In at least one embodiment, node C.R.s 316(1)-316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 316(1)-316(N) may correspond to a server or a cloud computing environment (e.g., 102) having one or more of the above-mentioned computing resources. In addition, in some embodiments, the node C.R.s 316(1)-3161(N) may include one or more virtual components, such as vGPUs, vCPUs, and/or the like, and/or one or more of the node C.R.s 316(1)-316(N) may correspond to a virtual machine (VM).

In at least one embodiment, grouped computing resources 314 may include separate groupings of node C.R.s 316 housed within one or more racks (not shown), or many racks housed in data centers at various geographical locations (also not shown). Separate groupings of node C.R.s 316 within grouped computing resources 314 may include grouped compute, network, memory or storage resources that may be configured or allocated to support one or more workloads. In at least one embodiment, several node C.R.s 316 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 312 may configure or otherwise control one or more node C.R.s 316(1)-316(N) and/or grouped computing resources 314. In at least one embodiment, resource orchestrator 312 may include a software design infrastructure (SDI) management entity for the data center 300. The resource orchestrator 312 may include hardware, software, or some combination thereof. Resource orchestrator 312 can be combined with or include the functionality of a framework manager 166 of the container framework 160 of a cloud computing environment 102.

In at least one embodiment, as shown in FIG. 3, framework layer 320 may include a job scheduler 328, a configuration manager 334, a resource manager 336, and/or a distributed file system 338. The framework layer 320 may include a framework to support software 332 of software layer 330 and/or one or more application(s) 342 of application layer 340. The framework layer 320 can include, be combined with, or include functionality of, the cloud computing environment 102, and vice versa. The software 332 or application(s) 342 may respectively include web-based service software or applications, such as those provided by Amazon Web Services, Google Cloud and Microsoft Azure. The framework layer 320 may be, but is not limited to, a type of free and open-source software web application framework such as Apache Spark™ (hereinafter “Spark”) that may utilize distributed file system 338 for large-scale data processing (e.g., “big data”). In at least one embodiment, job scheduler 328 may include a Spark driver to facilitate scheduling of workloads supported by various layers of data center 300. The configuration manager 334 may be capable of configuring different layers such as software layer 330 and framework layer 320 including Spark and distributed file system 338 for supporting large-scale data processing. The resource manager 336 may be capable of managing clustered or grouped computing resources mapped to or allocated for support of distributed file system 338 and job scheduler 328. In at least one embodiment, clustered or grouped computing resources may include grouped computing resource 314 at data center infrastructure layer 310. The resource manager 336 may coordinate with resource orchestrator 312 to manage these mapped or allocated computing resources.

In at least one embodiment, software 332 included in software layer 330 may include software used by at least portions of node C.R.s 316(1)-316(N), grouped computing resources 314, and/or distributed file system 338 of framework layer 320. One or more types of software may include, but are not limited to, Internet web page search software, e-mail virus scan software, database software, and streaming video content software.

In at least one embodiment, application(s) 342 included in application layer 340 may include one or more types of applications used by at least portions of node C.R.s 316(1)-316(N), grouped computing resources 314, and/or distributed file system 338 of framework layer 320. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 334, resource manager 336, and resource orchestrator 312 may implement any number and type of self-modifying actions based on any amount and type of data acquired in any technically feasible fashion. Self-modifying actions may relieve a data center operator of data center 300 from making possibly bad configuration decisions and possibly avoiding underutilized and/or poor performing portions of a data center.

The data center 300 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 300. In at least one embodiment, trained or deployed machine learning models corresponding to one or more neural networks may be used to infer or predict information using resources described above with respect to the data center 300 by using weight parameters calculated through one or more training techniques, such as but not limited to those described herein.

In at least one embodiment, the data center 300 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 200 of FIG. 2—e.g., each device may include similar components, features, and/or functionality of the computing device(s) 200. In addition, where backend devices (e.g., servers, NAS, etc.) are implemented, the backend devices may be included as part of a data center 300, an example of which is described in more detail herein with respect to FIG. 3.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, cloud computing environment 102, a distributed computing environment, a combination thereof, etc. A cloud-based network environment may include a framework layer, a job scheduler, a resource manager, and a distributed file system implemented on one or more of servers, or in a cloud computing environment 102, and which may include, or be integrated with, one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing (cloud computing environment 102) and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). For instance, a user can utilize the client device to access, utilize or implement applications 164 at containers 162, which the FSA framework 104 can monitor and/or control using FSA models 152 with states 112 and delays 122. A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 200 described herein with respect to FIG. 2. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

In some aspects, the technical solutions provided herein can include a system 100 and/or one or more processors 206 coupled with memory 204 storing instructions and data, for implementing a multi-state reconciliation finite state automata operator framework. For instance, the technical solutions herein can include a non-transitory computer-readable medium (e.g., memory 204) storing processor readable instructions, such that, when executed, causes a processor 206 of a server or a cloud computing system 102 to implement the features or functionalities of FSA framework 104. For example, one or more processors 206 can include one or more circuits (e.g., logic circuitry of a processing unit or memory 204), including for example, utilizing framework layer 320 or data center infrastructure layer 310.

One or more processors 206 coupled with memory 204 can be configured (e.g., utilize instructions stored in memory) to perform operations of a system 100. For instance, one or more processors 206 can identify one or more states between an initial state 112 and a final state 112 of an application 164. Application 164 can be executed by a service, such as a cloud computing environment 102, one or more servers, virtual machines, containers 162 or computing devices 200. The initial state 112 can be a state indicating application 164 initiation or deployment. The final state 112 can be a state indicating application 164 completion of execution or all tasks requested.

The one or more states 112 between the initial and final states 112 can any number of one or more states. For example, the one or more states 112 between the initial and final states 112 can include: a registered state 112 to indicate that the application 164 is registered with the system, a provisioned state 112 to indicate that the application is provisioned with resources, an available or a ready state 112 to indicate that the application is available or ready for use, an in-use or in-process states 112 to indicate that the application is being used or is in process, a commissioned state 112 to indicate that the application has been commissioned for a task, a decommissioned state 112 to indicate that the application has been decommissioned, an error state 112 to indicate that the application has experienced an error, a pause state 112 to indicate that the application is paused, an awaiting response state 112 to indicate that the application is awaiting a response, event or occurrence from another service, application or function. State 112 can be indicated, updated, reflected, identified or provided within a state matrix for the given application 164.

One or more processors 206 can identify one or more parameters corresponding to timing of implementation (e.g., delays 122) of the one or more states 112. For example, one or more processors can identify inputs, values, characters or parameters indicative of a delay 122 for a particular state. For example, a parameter for delay 122 can indicate a duration of time until the application 164 transitions to a next state 112. For example, a parameter for delay 122 can indicate a duration of time it takes for a current state 112 to be completed within the application 164. For example, a parameter for delay 122 can indicate a time at which the application 164 will complete the present state 112 and/or transition into the next state 112. Parameters corresponding to delays 122 can be indicated, updated, reflected, identified or provided within a delay matrix for the given application 164.

One or more processors 206 can provide an FSA model 152 that can be configured to monitor, track, control, update, adjust or otherwise manage progress corresponding to the one or more states 112 of the application 164. FSA model 152 can include, indicate, identify, establish, provide, adjust, dictate or control one or more states 112 of an application 164. FSA model 152 can include, indicate, identify, establish, provide, adjust, dictate or control one or more delays 122 pertaining to the particular one or more states 112 for the application 164.

One or more processors 206 can determine, using a first matrix (e.g., state matrix 114), a current state 112 of the one or more states 112 of the application 164. For example, the one or more processors 206 can utilize the FSA model 152 to identify, based on or using one or more parameters, entries or values of the state matrix 114, the current state 112. The current state 112 can be identified based on the indication from the state matrix 114. The current state 112 can be identified based on a parameter from one or more delays 122 indicated in the delay matrix 124. The current state 112 can be identified based on a time measurement, time stamp, a current time value, a start time value for the initial state and a period of time expired since the start of the operation of the application. The current state 112 can be estimated or determined based on, or using, the summation of delays 122 for the prior states 112, such as by adding the time delays 122 for all the prior states, starting from the starting of the application execution and the determining, based on the current time, at what state the application is currently operating.

One or more processors 206 can determine, using a second matrix (e.g., a delay matrix 124), a parameter, value or entry of the one or more parameters, values or entries corresponding to a timing of implementation (e.g., delays 122) of the current state 112. For example, one or more processors 206 can utilize the FSA model 152 to identify, based on or using one of the parameters of the delay matrix 124, a timing corresponding to the implementation of the current state 112. For example, FSA model 152 can determine any one or more of: a timing of a start of implementation of the current state 112, a time duration of implementation of the current state 112, a timing of an end of implementation of the current state 112, a time delay between the current time and the implementation or completion of the current state 112 and/or a time duration until transition to, or start of, the next state 112.

One or more processors 206 can provide to the service (e.g., container framework 160 and/or FSA framework 104) an indication of the progress of the application. The indication of the progress can include the current state 112 and/or the current delay 122 (e.g., time duration, time delay, timing of start and/or timing of completion) of the current state 112. The indication can be provided the container 162 processing the application 164. The indication can be provided to the computing system (e.g., 102 or 200). The indication can be transmitted, via a network, to a client device requesting the status of the application 164 process at the cloud computing environment 102. The client device can receive the indication, via a network, and can display the indication to a display of the client device or update a data structure for a client application communicating with the container framework 160 and tracking the progress of the application 164.

One or more processors 206 can include, execute, operate the service comprising a self-contained environment that includes a code and one or more resources to execute the application 164 (e.g., a container framework 160 or one or more containers 162). The one or more resources can include one or more of a cloud, a server, and a virtual machine. The one or more resources can include, for example, computation services (e.g., allocation and/or provisioning of processing power), memory services (e.g., allocation and/or provisioning of memory), storage services (e.g., allocation and/or provisioning of storage memory), networking services (e.g., allocation and/or provisioning of network bandwidth or network communication circuitry) or any other resource discussed herein.

The FSA model 152 can be configured to determine, using a third matrix (e.g., probabilistic matrix 134), a probability of the implementation of the current state. For example, the probabilistic matrix 134 can include one or more parameters indicative of the probability (e.g., between 0 and 100%) that the current state of the application is the determined current state 112. For instance, the probabilistic matrix 134 can indicate that there is a 30% probability that the current state is a first state 112 and 70% probability that the current state is a second state 112. FSA model 152 can be configured to provide, to the service (e.g., container 162, container framework 160, cloud computing system 102 or another device), the indication of the probability of the progress of the application with respect to the current state 112.

FSA model 152 can be configured to receive, from one of the service (e.g., container 162) or the application 164, the one or more states 112 via the first matrix (e.g., state matrix 114) and also receive, from one of the service (e.g., 162) or the application (e.g., 164), the one or more parameters (e.g., indicative of the delay 122) via the second matrix (e.g., delay matrix 124). FSA model 152 can be configured to identify the current state 112 of the application 164 from a plurality of states 112 between the initial state 112 and the final state 112 based at least on the first matrix (e.g., state matrix 114) indicating the plurality of states 112.

FSA model 152 can be configured to identify a remaining amount of time (e.g., delay 122) for the implementation of the current state 112 (e.g., time until the current state 112 is completed), based at least on the one or more parameters of the second matrix (e.g., delay matrix 124). FSA model 152 can be configured to output or provide the parameter corresponding to the timing of implementation of the current state 112 using a machine learning (ML) model 136 trained using data of a plurality of time intervals to complete a plurality of states of a plurality of applications executed by a plurality of services. ML model 136 can be trained to predict a time at which the current state 112 will be completed. ML model 136 can be trained to predict a time interval within which the current state 112 will be completed. ML model 136 can be trained or learning dynamically based on ongoing processing of the states 112 of the application to predict time intervals it takes to execute each of the states 112. ML model 136 can predict values or parameters for the delay matrix 124 or probabilistic matrix 134.

The first matrix (e.g., state matrix 114) can identify a current transition between two states out of the one or more states of the application between the initial state and the final state. For example, state matrix 114 can identify a transition between an available or a ready state 112 and an is-use or in-process state 112, both of which can be states that are in between the initial state 112 (e.g., state indicating initiation, deployment or installation of application) and a final state (e.g., state indicating that execution completed or application ready for a next task or execution).

The second matrix (e.g., state matrix 114) can identify the parameter indicative of a timing (e.g., delay 122) for implementation of the transition of the current state 112. FSA model 152 can utilize a third matrix (e.g., probabilistic matrix 134) which can indicate a probability of implementation of a state 112 of the one or more states 112. The probability can include a value determined based on a machine learning (ML) model 136 model trained using data of a plurality of states 112 of a plurality of applications 164 executed by a plurality of services (e.g., containers 162). For example, ML model 136 can be trained to determine possible current states 112 along with the probability for each state (e.g., that each of the possible states 112 is the actual state of the application 164).

One or more processors 206 can be a part of a system 100, which can be included in at least one of: a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system implemented using an edge device, a system implemented using a robot, a system for performing conversational AI operations, a system for generating synthetic data, a system incorporating one or more virtual machines (VMs), a system implemented at least partially in a data center, or a system implemented at least partially using cloud computing resources.

It should be understood that these and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

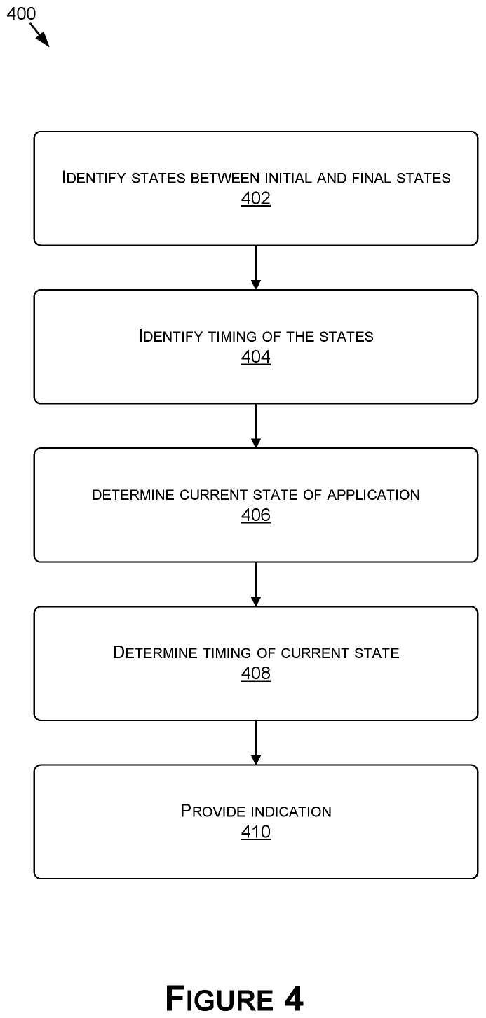

Now referring to FIG. 4, each block of method 400, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 400 is described, by way of example, with respect to the system of FIG. 1, which can also include any features of examples illustrated in FIGS. 2 and 3. However, this method may additionally or alternatively be executed by any one system, or any combination of systems, including, but not limited to, those described herein.

FIG. 4 shows a flow diagram of the method 400 for a multi-state reconciliation finite state automata operator framework. Method 400 can include acts 402-410. At 402, the method can identify one or more states between the initial state and the final state of the application. At 404, the method can identify the timing of the identified one or more states. At 406, the method can determine the current state of the application. At 408, the method can determine the timing of the current state. At 410, the method can provide indication.

At 402, the method can identify any state of an application. For example, the method can include one or more processors coupled with memory identifying one or more states that are between an initial state of an application and a final state of the application executed by a service. The application can be any application executed within a service, such as a container having contained resources (e.g., computing, memory, storage and other resources) along with the computer code sufficient to implement the execution of the application on the underlying hardware platform (e.g., server, computer or a cloud computing environment).

The identified one or more states can include any potential, possible or available states in which the application can be. For example, the one or more states can include any combination of: a registered state to indicate that the application is registered with the system, a provisioned state to indicate that the application is provisioned with resources, an available or a ready state to indicate that the application is available or ready for use, an in-use or in-process state to indicate that the application is being used or is in process, a commissioned state to indicate that the application has been commissioned for a task, a decommissioned state to indicate that the application has been decommissioned, an error state to indicate that the application has experienced an error, a pause state to indicate that the application is paused, an awaiting response state to indicate that the application is awaiting a response, event or occurrence from another service, application or function. State can be indicated, updated, reflected, identified or provided within a state matrix.

The method can include the one or more processors executing the application using the service (e.g., container) that includes a self-contained environment comprising a code and one or more resources. The one or more resources con include one or more of a cloud, a server, and a virtual machine, along with any computing features (e.g., processors, memories, storage, firmware, kernel, instructions, networking features or any other components of a computing system).

The method can include the one or more processors receiving, from one of the service or the application, the one or more states via the first matrix. For example, the application can provide application data that can include the parameters which the FSA framework can utilize to populate the state and delay matrices. Application data can include application state logic libraries. Application data can include instructions, such as handlers hooked to adjust, control, manage or implement a desired state of the application executed within the container in accordance with the expectations of the FSA model.

The method can include the one or more processors using the first matrix to identify a current transition between two states out of the one or more states of the application between the initial state and the final state. For instance, the state matrix can indicate a transition between one state and another, that a transition has occurred between two different states and/or that a transition is going to (e.g., is expected) to occur between two different states.

At 404, the method can identify the timing of the identified one or more states. For example, the method can include the one or more processors identifying one or more parameters corresponding to timing of implementation of the one or more states. The one or more parameters can be received within, or along with, application data received from the application. The one or more parameters can include values indicative of timing corresponding to one or more states of the application. For example, the one or more parameters can indicate the timing of each of the states, expected duration for each of the states, timing for when a transition between two states of the one or more states is going to occur, timing when each of the states begins and/or ends, and/or a duration of the entire execution across all the states.

The one or more processors can receive a parameter corresponding to a delay value for each individual state identified at 402. For example, with respect to four different states (e.g., between the initial and final state of the application), the method can include identifying parameters corresponding to delay or timing of each of the four different states. The method can include identifying the parameters corresponding to the delay or timing for all of the states of the application (e.g., including the initial and the final states). The method can include receiving, by the one or more processors, from one of the service (e.g., container) or the application (e.g., executed within the container), the one or more parameters of the timing or the delay, via the second matrix (e.g., the delay matrix). For instance, the parameters can be updated within the delay matrix and the one or more processors can retrieve the parameters from the delay matrix.

At 406, the method can determine the current state of the application. The method can include the one or more processors determining a current state of the one or more states of the application using a first matrix (e.g., state matrix) of a model (e.g., FSA model) configured to manage progress corresponding to one or more states of the application. The method can include the one or more processors identifying, using the model (e.g., FSA model), the current state of the application from a plurality of states between the initial state and the final state. The FSA model can identify the current state of the application based at least on the first matrix (e.g., state matrix) indicating the plurality of states.

For example, the FSA model can determine the current state by reading a value indicated in a parameter of the state matrix. The FSA model can determine the current state by considering the delay data from the delay matrix together with the data of the state matrix. For example, the FSA model can determine the current state by calculating the amount of time passed since the start of the processing or last indication (e.g., state transition) and determining, based on one or more delay values, the current state of the application.

The method can include the one or more processors determining, using a third matrix (e.g., probability matrix), a probability of the implementation of the current state. The probability matrix can include values corresponding to probabilities that one or more states are the current state of the application. The probability matrix can include values determined based on a ML model trained using data comprising a plurality of states and state transitions along with timing parameters (e.g., delays) for each of the states and/or transitions. The probability matrix can include, for example, a first probability value corresponding to a probability that a first state of the plurality of states is the current state and a second probability value corresponding to a probability that a second state of the plurality of states is the current state. For example, the method can include the one or more processors identifying, using a third matrix (e.g., probability matrix) indicating a probability of implementation of a state of the one or more states. The probability can be a value determined using a machine learning (ML) model trained using data of a plurality of states of a plurality of applications executed by a plurality of services.

At 408, the method can determine the timing of the current state. The method can include the one or more processors determining, using a second matrix (e.g., delay matrix) of the model (e.g., FSA model), a parameter of the one or more parameters corresponding to a timing (e.g., delay value) of implementation of the current state. For example, the FSA model can determine the time period to complete the current state. The FSA model can determine the time it takes to transition to the next state. The FSA model can determine the duration of time for which the current state is expected to last. The FSA model can determine the total time duration of the current state. The FSA model can utilize the entries (e.g., parameters) of the state matrix and the delay matrix to determine the remaining duration of the current state.

The method can include generating, updating or providing the parameters or values of the delay matrix and/or probabilistic matrix using a machine learning (ML) model. The ML model can be trained using data of timing, delays, time durations or a plurality of time intervals to complete a plurality of states of one or more applications, such as applications executed by a plurality of services. ML model can monitor processing of the states and determine, based on prior times it has taken to implement particular tasks, the timing, time intervals, expected time duration or expected time range within which a particular state (e.g., current state) can be completed. Delay matrix and/or probabilistic matrix can include outputs pertaining to the expected time range, time duration or timing of the state completions, state transitions which can be provided by, or be implemented using, outputs from the ML model(s).

The one or more processors can identify the parameter(s) indicative of a timing for implementation of the current transition using the second matrix (e.g., delay matrix). The one or more processors can identify, using the FSA model, a remaining amount of time for the implementation of the current state based at least on the one or more parameters of the second matrix (e.g., delay matrix). The one or more processors can identify, using the ML model trained or updated with information on delays of the states of one or more applications, a remaining amount of time for the implementation of the current state. The ML model can determine a specific amount of time, a range of time, a range of time associated with a likelihood or probability that the current time will be implemented within that time range.

At 410, the method can provide an indication of a current progress or current state of a process, operation, or task. The method can include the one or more processors providing an indication of the progress of the application to the service. For example, the one or more processors can provide the indication to any one or more of an FSA model, FSA framework, container framework or the container within which the application is processed. The one or more processors can generate the indication for a client device processing the application at the container, using the cloud computing environment via a network. The method can include the one or more processors providing, to the service, the indication of the probability of the progress of the application with respect to the current state, such as a probability that the current state is going to be changed within a given time interval (e.g., delay value).

The method can include the one or more processors sending one or more instructions to the container or the application to take action. The action can include, for example, adjusting, correcting, controlling the state of the application, or its processing. For example, the FSA model can trigger the one or more processors to issue or generate an instruction (e.g., a hooked handler or command) to cause the application to update its state, restart its processing, end a delay, implement a change, or complete a state transition.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A system, comprising:
one or more processing units coupled with memory to perform operations comprising:
identifying one or more states between an initial state and a final state of an application executed by a service;
identifying one or more parameters corresponding to timing of one or more implementations of the one or more states; and
providing a model configured to manage progress corresponding to the one or more states of the application to:
determine, using a first matrix, a current state of the one or more states of the application;
determine, using a second matrix, a parameter of the one or more parameters corresponding to a timing of implementation of the current state; and
provide to the service an indication of the progress of the application.

2. The system of claim 1, wherein the service comprises a self-contained environment comprising a portion of code and one or more resources to execute the application, wherein the one or more resources comprises one or more of a cloud, a server, or a virtual machine.

3. The system of claim 1, wherein the model is configured to:
determine, using a third matrix, a probability of an implementation of the current state; and
provide, to the service, the indication of the probability of the progress of the application with respect to the current state.

4. The system of claim 1, wherein the model is configured to:
receive the one or more states via the first matrix; and
receive the one or more parameters via the second matrix.

5. The system of claim 1, wherein the model is configured to identify the current state of the application from a plurality of states between the initial state and the final state based at least on the first matrix indicating the plurality of states.

6. The system of claim 1, wherein the model is configured to identify a remaining amount of time for an implementation of the current state based at least on the one or more parameters of the second matrix.

7. The system of claim 1, wherein the parameter corresponding to the timing of an implementation of at least one state of the one or more states is provided by a machine learning (ML) model updated using data of a plurality of time intervals to complete a plurality of states of a plurality of applications executed by a plurality of services.

8. The system of claim 7, wherein the second matrix identifies the parameter indicative of a timing for implementation of the current state.

9. The system of claim 1, comprising a third matrix indicating a probability of implementation of a state of the one or more states, the probability determined based on a machine learning (ML) model trained using data of a plurality of states of a plurality of applications executed by a plurality of services.

10. The system of claim 1, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

11. A method, comprising:
identifying, using one or more processors coupled with memory, one or more states between an initial state and a final state of an application executed by a service;
identifying, using the one or more processors, one or more parameters corresponding to timing of implementation of the one or more states;
determining, using the one or more processors, using a first matrix of a model configured to manage progress corresponding to one or more states of the application, a current state of the one or more states of the application;
determining, using the one or more processors, using a second matrix of the model, a parameter of the one or more parameters corresponding to a timing of implementation of the current state; and
providing, using the one or more processors, to the service an indication of the progress of the application.

12. The method of claim 11, comprising:
executing, using the one or more processors and the service that includes a self-contained environment comprising a code and one or more resources, the application, wherein the one or more resources comprises one or more of a cloud, a server, and a virtual machine.

13. The method of claim 11, comprising:
determine, using the one or more processors and a third matrix, a probability of the implementation of the current state; and
providing, to the service and using the one or more processors, the indication of the probability of the progress of the application with respect to the current state.

14. The method of claim 11, comprising:
receiving, using the one or more processors and from one of the service or the application, the one or more states via the first matrix; and
receiving, using the one or more processors and from one of the service or the application, the one or more parameters via the second matrix.

15. The method of claim 11, comprising:
identifying, using the one or more processors and the model, the current state of the application from a plurality of states between the initial state and the final state based at least on the first matrix indicating the plurality of states.

16. The method of claim 11, comprising:
identifying, using the one or more processors and the model, a remaining amount of time for the implementation of the current state based at least on the one or more parameters of the second matrix.

17. The method of claim 1, comprising:
identifying, using the one or more processors and the first matrix, a current transition between two states out of the one or more states of the application between the initial state and the final state; and
identifying, using the one or more processors and the second matrix, the parameter indicative of a timing for implementation of the current transition.

18. The method of claim 11, comprising:
identifying, using the one or more processors and a third matrix, a probability of implementation of a state of the one or more states, the probability determined based on a machine learning (ML) model updated using data of a plurality of states of a plurality of applications executed by a plurality of services.

19. A processor, comprising:
one or more circuits to:
identify one or more states between an initial state and a final state of an application executed by a service;
identify one or more parameters corresponding to timing of implementation of the one or more states; and
provide a model configured to manage progress corresponding to the one or more states of the application to:
determine, using a first matrix, a current state of the one or more states of the application;
determine, using a second matrix, a parameter of the one or more parameters corresponding to a timing of implementation of the current state; and
provide to the service an indication of the progress of the application.

20. The processor of claim 19, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.
